(19) United States
(12) Patent Application Publication
(10) Pub. No.: US 2024/0217715 A1
(43) Pub. Date: Jul. 4, 2024

(54) DEGRADABLE, BIODEGRADABLE, AND/OR COMPOSTABLE PACKAGES CONTAINING PHASE CHANGE MATERIAL

(71) Applicant: Phase Change Energy Solutions, Inc., Greensboro, NC (US)

(72) Inventors: Reyad I. SAWAFTA, Greensboro, NC (US); Byron C. OWENS, Greensboro, NC (US)

(21) Appl. No.: 18/563,164

(22) PCT Filed: May 25, 2022
(86) PCT No.: PCT/US2022/030889

§ 371 Date: Nov. 21, 2023

Related U.S. Application Data
(60) Provisional application No. 63/192,849, filed on May 25, 2021.

(51) Int. Cl. B65D 65/46; B65D 81/38

(52) U.S. Cl. CPC B65D 65/46; B65D 81/382

(57) ABSTRACT

In one aspect, packages are described herein which include a shell and a phase change material disposed in the shell. The shell and the phase change material each have a degradability selected from the group consisting of (a) degradable, (b) biodegradable, (c) industrially compostable, and (d) home compostable. In some embodiments, the shell and the phase change material have the same degradability selected from the foregoing group.

### CROSS REFERENCE TO RELATED APPLICATIONS

This application claims priority pursuant under 35 U.S.C. § 119 to U.S. Provisional Patent Application No. 63/192,849 filed May 25, 2021, which is hereby incorporated by reference in its entirety.

### FIELD

The present disclosure relates to packages and/or packaged materials including phase change material in which one or more of a payload and an exterior shell or package are (a) degradable, (b) biodegradable, (c) industrially compostable, and/or (d) home compostable. The present disclosure also relates to methods of managing the temperature of an article or an environment using one or more such articles. Further, the present disclosure relates to articles or methods including interior and/or exterior materials which may have the same or similar levels of degradability or compostability.

### BACKGROUND

Manufacturers and consumers alike in a wide array of industries are increasingly identifying the advantages of reducing landfill waste and increasing the usage of degradable, biodegradable, industrially compostable, and home compostable products. This trend includes single-use items, reusable items, and the packaging thereof. Environments or use cases which may benefit from the use of phase change materials for thermal resiliency and/or energy use reduction may similarly benefit from manufacturing items which adhere to these degradability standards.

In view of these considerations, there is increasing demand for a reusable phase change material containing package which maintains an impermeable, substantially impermeable, or semi-impermeable barrier between the phase change material and the payload or environment used in combination with the phase change material, but which is also suitably degradable, biodegradable, industrially compostable, or home compostable as may be appropriate for the particular performance parameters and disposability of the entire package containing phase change material.

Improved packages containing phase change materials and methods of making and using such packages are therefore desired.

### SUMMARY

In one aspect, packages are described herein which, in some embodiments, provide one or more advantages compared to other packages. For example, in some cases, a package described herein can be readily disposed of in a more sustainable or environmentally friendly manner after the package is used. In some embodiments, a package described herein comprises a shell and a phase change material (PCM) disposed in the shell, wherein the shell and the PCM each have a degradability selected from the group consisting of (a) degradable, (b) biodegradable, (c) industrially compostable, and (d) home compostable. Moreover, in some cases, the shell and the PCM are selected to have the same level of degradability selected from the group consisting of (a) degradable, (b) biodegradable, (c) industrially compostable, and (d) home compostable.

In another aspect, methods of making a package are described herein. In some implementations, such a method comprises forming a shell from a first material and disposing at least one PCM in the shell, wherein the shell and the PCM each have a degradability selected from the group consisting of (a) degradable, (b) biodegradable, (c) industrially compostable, and (d) home compostable. Additionally, in some embodiments, the method further comprises non-reversibly sealing the shell to encapsulate the PCM.

In yet another aspect, methods of transporting a product or payload are described herein. In some cases, a method of transporting a product comprises placing a package described herein in an interior volume of a container and also placing the product in the interior volume of the container. The method can further comprise transporting the container from a first location to a second location and removing the product from the interior volume of the container (e.g., upon arrival at the second location, after the container has been loaded with the payload and package at the first location). Moreover, in some instances, the method further comprises heating or cooling the PCM of the package above or below a phase transition temperature of the PCM prior to placing the product in the interior volume of the container (e.g., to “charge” the PCM). Additionally, in some embodiments, a method described herein further comprises removing the product from the container (e.g., at the second location or some other destination) and degrading both the shell and the PCM together (e.g., without removing the PCM from the shell). For example, in some cases, both the shell and the PCM are degraded together using a biological process, or by industrially composting both the shell and the PCM together, or by home composting both the shell and the phase change material together.

These and other embodiments are described in more detail below.

### BRIEF DESCRIPTION OF THE DRAWINGS

FIG. 1 illustrates a perspective view of a package according to one embodiment described herein.

FIG. 2 illustrates a sectional view of the package of FIG. 1 along lines 2-2.

FIG. 3 illustrates a perspective view of a container comprising packages according to one embodiment described herein.

### DETAILED DESCRIPTION

Implementations and embodiments described herein can be understood more readily by reference to the following detailed description, examples, and drawings. Elements, apparatus, and methods described herein, however, are not limited to the specific implementations presented in the detailed description, examples, and drawings. It should be recognized that these implementations are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum of 1.0 or more and ending with a maximum value of 10.0 or less, e.g., 1.0 to 5.3, or 4.7 to 10.0, or 3.6 to 7.9. Similarly, as will be clearly understood, a stated range of “1 to 10” should be considered to include any and all subranges beginning with a minimum of 1 or more and ending with a maximum value of 10 or less, e.g., 1 to 6, or 7 to 10, or 3.6 to 7.9.

All ranges disclosed herein are also to be considered to include the end points of the range, unless expressly stated otherwise. For example, a range of “between 5 and 10,” “from 5 to 10,” or “5-10” should generally be considered to include the end points of 5 and 10.

Additionally, the use of a singular article (such as “a” or “an”) in conjunction with a noun/item is to be considered to mean “one or more” of the noun/item, unless the context indicates only a single noun/item.

I. Degradable, Biodegradable, and/or Compostable Articles or Packages Including Phase Change Materials (PCMs)

Articles or packages are described herein which comprise or include at least an outer or exterior envelope, film, or shell (referred to hereafter collectively as the “shell”) comprising or formed from a first material and an interior or inner phase change material disposed within the exterior shell. As described herein, one or both of the shell and the phase change material have a degradability which is selected from the group consisting of (a) degradable, (b) biodegradable, (c) industrially compostable, and (d) home compostable.

Degradable materials, as discussed herein, are those materials which are capable of being decomposed chemically or biologically. More specifically, a degradable polymeric and/or plastic material undergoes scission of the main chains or side-chains of polymer molecules to form degradation products having a molecular weight no greater than 10% of the molecular weight of the original material(s). Scission of this type may be induced by thermal activation, oxidation, photolysis, radiolysis, or hydrolysis.

Biodegradable materials are those materials which are degraded in biological environments (including, without limitation: soils, seas, rivers, and lakes, as well as in the body of human beings and animals). Additionally and/or alternatively, biodegradable materials are those materials which are degraded by a biological process. In reference to polymeric and/or plastic materials, biodegradable materials are, in some cases, those which may undergo such degradation not through thermal oxidation, photolysis, or radiolysis, but instead through enzymatic or non-enzymatic hydrolysis. More specifically, and as referenced herein, a material is considered “readily biodegradable” if the material qualifies as such under an OECD 301 series (OECD 301A, OECD 301B, OECD 301C, OECD 301D, OECD 301E, OECD 301F) test for ready or ultimate biodegradability. OECD Guidelines and pass levels for the testing of chemicals for Ready Biodegradability may be found at: https://doi.org/10.1787/9789264070349-en. Under an OECD 301 series test, a material is considered Readily Biodegradable under the following metric (as defined under OECF 301 series test pass parameters):
The pass levels for ready biodegradability are 70% removal of DOC and 60% of ThOD or ThCO₂ production for respirometric methods. They are lower in the respirometric methods since, as some of the carbon from the test chemical is incorporated into new cells, the percentage of CO2 produced is lower than the percentage of carbon being used. These pass values have to be reached in a 10-d window within the 28-d period of the test. The 10-d window begins when the degree of biodegradation has reached 10% DOC, ThOD or ThCO2 and must end before day 28 of the test. Chemicals which reach the pass levels after the 28-d period are not deemed to be readily biodegradable.

Compostable materials are those materials which sufficiently disintegrate, biodegrade, and have an ecological impact within a defined range as defined by standard tests. Compostable materials may be sub-categorized to include industrially compostable materials and home compostable materials. The industrial compostability of a material may be defined by ASTM D6400, which is a specification providing criteria to make claims of “compostable”. Disintegration is evaluated by sieving a compost-plastic mixture after a set time to measure the amount of plastic that passes through the sieve. Biodegradation under ASTM D6400 is a measure of the conversion of organic carbon to CO₂ under aerobic, thermophilic composting conditions (as measured by, e.g., ASTM D5338). Ecological impacts for such a determination may be made, for example, by OECD 208. A material may be deemed compostable if all threshold criteria are met. By contrast, the home compostability of a material may be defined by Australian standard AS 5810, entitled Biodegradable plastics suitable for home composting. This standard requires disintegration in six months, and biodegradation and compost formation in a year.

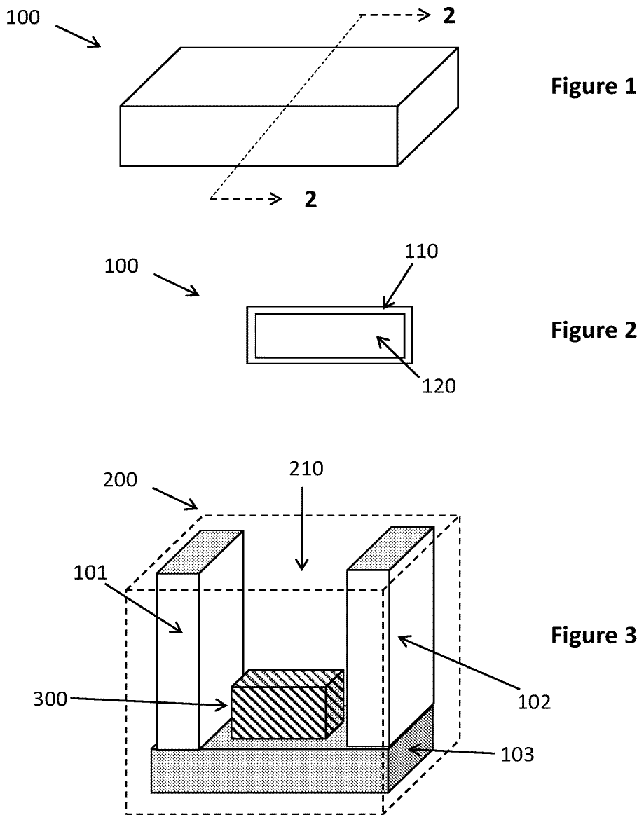

One example embodiment of a package described herein is illustrated in FIG. 1 and FIG. 2. With reference to these figures, a package (100) is generally brick-shaped, or shaped like a rectangular prism. Other shapes are also possible, and the specific length, width, and height of the package (100) are not particularly limited. FIG. 1 illustrates the outside of the package (100). As seen most clearly in FIG. 2, which is a sectional view of the package (100), taken along the lines 2-2, the package (100) comprises a shell (110), which is like a skin or outer portion of the package (100), as described further herein. The package (100) also comprises a PCM (120). As illustrated in FIG. 2, and as described further herein, the PCM (120) can be considered to be a “block” or “brick” of PCM wrapped or packaged in the shell (110). The PCM (120), in some cases, can be a solid or gel brick or block. It is also possible, in other cases, for the PCM (120) to be a liquid. It is further to be understood that the package (100) could be an envelope or a pouch that is a stand-alone envelope or pouch or that is part of a larger container, such as a container with one or more “sleeves” for containing a PCM component. In some such instances, the pouch or sleeve material could be the shell (120) of the package (100). In other cases, the pouch or sleeve material is different than the shell (120), and the entire package (100), as a packaged PCM product, is disposed within the pouch or sleeve.

Shells described herein may comprise or be formed from any material not inconsistent with the objectives of the present disclosure. For example, in some embodiments, shells may comprise or be formed from one or more of the following materials or mixtures thereof: starch-based plastics, bacteria-based plastics, soy-based plastics, cellulose-based plastics, lignin-based plastics, and natural fiber reinforced plastics. In some instances, a shell may comprise or include a biopolymer or biopolymeric material. Such materials may be formed from or prepared using protein, polysaccharide, or lipid materials. For example, in some non-limiting embodiments, a shell comprises or includes one or more polymers or polymeric mixtures comprising or including polycaprolactone (PCL), polyvinyl alcohol (PVA), polyhydroxybutyrate (PHB), polyglycolides (PGA), and/or polylactic acids (PLA). Additionally, certain thermoplastic elastomers (TPE) may be used, such as styrenic block copolymers (TPS).

A shell of a package described herein may have any form factor not inconsistent with the objectives of the present disclosure. For example, in some embodiments, a shell may form a flexible outer layer such as a film, pack, or pouch. In certain other embodiments, a shell may form a more rigid structure, such as a box, case, or brick. A shell described herein has a plastic or melt temperature which is higher than, such as substantially higher than, a phase transition temperature of a phase change material disposed within the shell, thus providing a container for the phase change material in both a first phase below the phase transition temperature of the phase change material and a second phase above the phase transition temperature of the phase change material.

Additionally, in some embodiments, the shell is permanently or otherwise non-reversibly closed or sealed to contain the phase change material. In this manner, the phase change material may be disposed within the shell indefinitely until the entire package degrades, biodegrades, or is composted. Further, in some embodiments, the shell is not soluble or miscible in water, or is substantially insoluble or immiscible in water.

Shells described herein have at least one phase change material disposed therein. Any phase change material (“PCM”) or combination of PCMs not inconsistent with the objectives of the present disclosure may be used in a system or method described herein. PCMs in systems described herein may be selected individually or may be selected to have coordinating or cooperating phase transition temperatures. Moreover, the PCM (or combination of PCMs) used in a particular instance can be selected based on a relevant operational temperature range for the specific end use or application, such as a desired temperature or thermal capacity at a certain temperature or across a desired range of temperatures. As understood by one having ordinary skill in the art, a phase transition temperature described herein (such as a phase transition temperature of “X” ° C., where X may be −20° C., for example) may be represented as a normal distribution of temperatures centered on X° C. In addition, as understood by one having ordinary skill in the art, a PCM described herein can exhibit thermal hysteresis, such that the PCM exhibits a phase change temperature difference between the “forward” phase change and the “reverse” phase change (e.g., a solidification temperature that is different from the melting temperature). In some embodiments, the PCM has a phase transition temperature within one of the ranges of Table 1 below.

TABLE 1
Phase transition temperature ranges for PCMs (at a pressure of 1 atm).
Phase Transition Temperature Ranges
−10° C. to 0° C.
−20° C. to −10° C.
−25° C. to −15° C.
−30° C. to −20° C.
−30° C. to −10° C.
−50° C. to −30° C.
−50° C. to 0° C.

| | |
|---|---|
| 0-6° | C. |
| 6-8° | C. |
| 2-8° | C. |
| 0-10° | C. |
| 0-15° | C. |
| 0-20° | C. |
| 8-25° | C. |
| 10-30° | C. |
| 15-25° | C. |
| 20-30° | C. |
| 30-50° | C. |

Moreover, in certain embodiments, it may be desirable or even preferable that a phase transition temperature of one PCM or mixture of PCMs is at or near a temperature of an item, payload, or environmental desired temperature. Any desired room temperature or external temperature and associated phase transition temperature can be used.

As described further herein, a particular range can be selected based on the desired application. For example, PCMs having a phase transition temperature of 6-8° C. can be especially desirable for maintaining the temperature of a payload which may otherwise be stored in a refrigerated environment. As another non-limiting example, PCMs having a phase transition between −40° C. and −10° C., and more specifically between −25° C. and −15° C. can be preferred for use with payloads which otherwise may be stored in a commercial freezer, or as an intermediate layer. Additionally, PCMs having a phase transition temperature of between 15° C. and 25° C. may be preferred for temperature resiliency of a residential or commercial building space.

Further, a PCM of a package described herein can either absorb or release energy using any phase transition not inconsistent with the objectives of the present disclosure. For example, the phase transition of a PCM described herein, in some embodiments, comprises a transition between a solid phase and a liquid phase of the PCM, or between a solid phase and a mesophase of the PCM. A mesophase, in some cases, is a gel phase. Thus, in some instances, a PCM undergoes a solid-to-gel transition. A solid to solid transition is also possible. Further, in some embodiments, a PCM undergoes a solid to gas transition.

Moreover, in some cases, a PCM or mixture of PCMs has a phase transition enthalpy or latent heat of at least about 50 kJ/kg or at least about 100 kJ/kg. In other embodiments, a PCM or mixture of PCMs has a phase transition enthalpy of at least about 150 kJ/kg, at least about 200 kJ/kg, at least about 300 kJ/kg, or at least about 350 kJ/kg. In some instances, a PCM or mixture of PCMs has a phase transition enthalpy between about 50 kJ/kg and about 350 kJ/kg, between about 100 kJ/kg and about 350 kJ/kg, between about 100 kJ/kg and about 220 kJ/kg, or between about 100 kJ/kg and about 250 kJ/kg. In certain instances, a PCM or mixture of PCMs has a phase transition enthalpy of between about 75 kJ/kg and about 225 kJ/kg, between about 100 kJ/kg and about 250 kJ/kg, between about 125 kJ/kg and 275 kJ/kg, between about 150 kJ/kg and about 300 kJ/kg, or between about 200 kJ/kg and about 350 kJ/kg.

In addition, a PCM of a package described herein can have any composition not inconsistent with the objectives of the present disclosure. In some embodiments, a PCM comprises a fatty acid. A fatty acid, in some embodiments, can have a C4 to C28 aliphatic hydrocarbon tail. Further, in some embodiments, the hydrocarbon tail is saturated. Alternatively, in other embodiments, the hydrocarbon tail is unsaturated. In some embodiments, the hydrocarbon tail can be branched or linear. Non-limiting examples of fatty acids suitable for use in some embodiments described herein include caprylic acid, capric acid, lauric acid, myristic acid, palmitic acid, stearic acid, arachidic acid, behenic acid, lignoceric acid, and cerotic acid. In some embodiments, a PCM described herein comprises a combination, mixture, or plurality of differing fatty acids. For reference purposes herein, it is to be understood that a chemical species described as a “Cn” species (e.g., a “C4” species or a “C28” species) is a species of the identified type that includes exactly “n” carbon atoms. Thus, a C4 to C28 aliphatic hydrocarbon tail refers to a hydrocarbon tail that includes between 4 and 28 carbon atoms.

In some embodiments, a PCM comprises an alkyl ester of a fatty acid. Any alkyl ester not inconsistent with the objectives of the present disclosure may be used. For instance, in some embodiments, an alkyl ester comprises a methyl ester, ethyl ester, isopropyl ester, butyl ester, or hexyl ester of a fatty acid described herein. In other embodiments, an alkyl ester comprises a C2 to C6 ester alkyl backbone or a C6 to C12 ester alkyl backbone. In some embodiments, an alkyl ester comprises a C12 to C28 ester alkyl backbone. Further, in some embodiments, a PCM comprises a combination, mixture, or plurality of differing alkyl esters of fatty acids. Non-limiting examples of alkyl esters of fatty acids suitable for use in some embodiments described herein include methyl laurate, methyl myristate, methyl palmitate, methyl stearate, methyl palmitoleate, methyl oleate, methyl linoleate, methyl docosahexanoate, methyl ecosapentanoate, ethyl laurate, ethyl myristate, ethyl palmitate, ethyl stearate, ethyl palmitoleate, ethyl oleate, ethyl linoleate, ethyl docosahexanoate, ethyl ecosapentanoate, isopropyl laurate, isopropyl myristate, isopropyl palmitate, isopropyl stearate, isopropyl palmitoleate, isopropyl oleate, isopropyl linoleate, isopropyl docosahexanoate, isopropyl ecosapentanoate, butyl laurate, butyl myristate, butyl palmitate, butyl stearate, butyl palmitoleate, butyl oleate, butyl linoleate, butyl docosahexanoate, butyl ecosapentanoate, hexyl laurate, hexyl myristate, hexyl palmitate, hexyl stearate, hexyl palmitoleate, hexyl oleate, hexyl linoleate, hexyl docosahexanoate, and hexyl ecosapentanoate.

In some embodiments, a PCM comprises a fatty alcohol. Any fatty alcohol not inconsistent with the objectives of the present disclosure may be used. For instance, a fatty alcohol, in some embodiments, can have a C4 to C28 aliphatic hydrocarbon tail. Further, in some embodiments, the hydrocarbon tail is saturated. Alternatively, in other embodiments, the hydrocarbon tail is unsaturated. The hydrocarbon tail can also be branched or linear. Non-limiting examples of fatty alcohols suitable for use in some embodiments described herein include capryl alcohol, pelargonic alcohol, capric alcohol, undecyl alcohol, lauryl alcohol, tridecyl alcohol, myristyl alcohol, pentadecyl alcohol, cetyl alcohol, heptadecyl alcohol, stearyl alcohol, nonadecyl alcohol, arachidyl alcohol, heneicosyl alcohol, behenyl alcohol, lignoceryl alcohol, ceryl alcohol, and montanyl alcohol. In some embodiments, a PCM comprises a combination, mixture, or plurality of differing fatty alcohols.

In some embodiments, a PCM comprises a fatty carbonate ester, sulfonate, or phosphonate. Any fatty carbonate ester, sulfonate, or phosphonate not inconsistent with the objectives of the present disclosure may be used. In some embodiments, a PCM comprises a C4 to C28 alkyl carbonate ester, sulfonate, or phosphonate. In some embodiments, a PCM comprises a C4 to C28 alkenyl carbonate ester, sulfonate, or phosphonate. In some embodiments, a PCM comprises a combination, mixture, or plurality of differing fatty carbonate esters, sulfonates, or phosphonates. In addition, a fatty carbonate ester described herein can have two alkyl or alkenyl groups described herein or only one alkyl or alkenyl group described herein.

Moreover, in some embodiments, a PCM comprises a paraffin. Any paraffin not inconsistent with the objectives of the present disclosure may be used. In some embodiments, a PCM comprises n-dodecane, n-tridecane, n-tetradecane, n-pentadecane, n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane, n-octacosane, n-nonacosane, n-triacontane, n-hentriacontane, n-dotriacontane, n-tritriacontane, and/or mixtures thereof.

In addition, in some embodiments, a PCM comprises a polymeric material. Any polymeric material not inconsistent with the objectives of the present disclosure may be used. Non-limiting examples of suitable polymeric materials for use in some embodiments described herein include thermoplastic polymers (e.g., poly(vinyl ethyl ether), poly(vinyl n-butyl ether) and polychloroprene), polyethylene glycols (e.g., CARBOWAX® polyethylene glycol 400, CARBOWAX® polyethylene glycol 600, CARBOWAX® polyethylene glycol 1000, CARBOWAX® polyethylene glycol 1500, CARBOWAX® polyethylene glycol 4600, CARBOWAX® polyethylene glycol 8000, and CARBOWAX® polyethylene glycol 14,000), and polyolefins (e.g., lightly crosslinked polyethylene and/or high density polyethylene).

Additional non-limiting examples of phase change materials suitable for use in some embodiments described herein include BioPCM materials commercially available from Phase Change Energy Solutions (Asheboro, North Carolina), such as BioPCM-(−8), BioPCM-(−6), BioPCM-(−4), BioPCM-(−2), BioPCM-4, BioPCM-6, BioPCM 08, BioPCM-Q12, BioPCM-Q15, BioPCM-Q18, BioPCM-Q20, BioPCM-Q21, BioPCM-Q23, BioPCM-Q25, BioPCM-Q27, BioPCM-Q30, BioPCM-Q32, BioPCM-Q35, BioPCM-Q37, BioPCM-Q42, BioPCM-Q49, and others.

Furthermore, the PCM composition may comprise (a) one or more fatty acids, one or more alkyl esters of a fatty acid, one or more fatty alcohols, one or more fatty sulfonates or phosphonates or sulfates or carbonates, or a combination thereof and/or (b) one or more inorganic salt hydrates, or a combination thereof, and/or (c) one or more ionic liquids, or a combination thereof.

It is further to be understood that a device described herein can comprise a plurality of differing PCMs, including differing PCMs of differing types. Any mixture or combination of differing PCMs not inconsistent with the objectives of the present disclosure may be used. In some embodiments, for example, a thermal storage cell and/or mixture of PCMs comprises or includes one or more fatty acids and one or more fatty alcohols. Further, as described above, a plurality of differing PCMs, in some cases, is selected based on a desired phase transition temperature and/or latent heat of the mixture of PCMs.

Further, in some embodiments, one or more properties of a PCM described herein can be modified by the inclusion of one or more additives. Such an additive described herein can be mixed with a PCM and/or disposed in a device described herein. In some embodiments, an additive comprises a thermal conductivity modulator. A thermal conductivity modulator, in some embodiments, increases the thermal conductivity of the PCM. In some embodiments, a thermal conductivity modulator comprises carbon, including graphitic carbon. In some embodiments, a thermal conductivity modulator comprises carbon black and/or carbon nanoparticles. Carbon nanoparticles, in some embodiments, comprise carbon nanotubes and/or fullerenes. In some embodiments, a thermal conductivity modulator comprises a graphitic matrix structure. In other embodiments, a thermal conductivity modulator comprises an ionic liquid. In some embodiments, a thermal conductivity modulator comprises a metal, including a pure metal or a combination, mixture, or alloy of metals. Any metal not inconsistent with the objectives of the present disclosure may be used. In some embodiments, a metal comprises a transition metal, such as silver or copper. In some embodiments, a metal comprises an element from Group 13 or Group 14 of the periodic table. In some embodiments, a metal comprises aluminum. In some embodiments, a thermal conductivity modulator comprises a metallic filler dispersed within a matrix formed by the PCM. In some embodiments, a thermal conductivity modulator comprises a metal matrix structure or cage-like structure, a metal tube, a metal plate, and/or metal shavings. Further, in some embodiments, a thermal conductivity modulator comprises a metal oxide. Any metal oxide not inconsistent with the objectives of the present disclosure may be used. In some embodiments, a metal oxide comprises a transition metal oxide. In some embodiments, a metal oxide comprises alumina.

In other embodiments, an additive comprises a nucleating agent. A nucleating agent, in some embodiments, can help avoid sub-cooling, particularly for PCMs comprising finely distributed phases, such as fatty alcohols, paraffinic alcohols, amines, paraffins, or for certain salt hydrate containing solutions. Any nucleating agent not inconsistent with the objectives of the present disclosure may be used. In still other instances, an additive comprises a fire retardant or fire-resistant material.

In some embodiments, both the shell and the phase change material are degradable, but not biodegradable, industrially compostable, or home compostable. In certain other embodiments, both the shell and the phase change material are degradable and biodegradable, but not industrially compostable or home compostable. In further embodiments, both the shell and the phase change material are degradable, biodegradable, and industrially compostable, but not home compostable. In yet further embodiments, both the film and the phase change material are degradable, biodegradable, industrially compostable, and home compostable. In certain embodiments, the shell and the phase change material are selected to have the same degradability (i.e., degradability selected from degradable, biodegradable, industrially compostable, and home compostable). In such embodiments, a method or location of disposal, biodegradation, industrial composting facility, or home composting can be selected which is equally suitable for both the shell and the phase change material.

### II. Methods of Creating or Maintaining a Temperature-Controlled Environment or Transporting a Product or Payload

In another aspect, methods of making packages containing phase change materials are described herein. In a further aspect, methods of managing the temperature of an environment or payload are described herein. In a yet further aspect, methods of disposing of packages containing phase change material are described herein.

In some embodiments, a method described herein comprises disposing a phase change material within a shell, wherein each of the phase change material and the shell have a degradability selected from (a) degradable, (b) biodegradable, (c) industrially compostable, and (d) home compostable. Any shell described herein in Section I may be used. Similarly, any PCM described herein above in Section I may be used. In some embodiments, the shell is degradable and the PCM is degradable, biodegradable, industrially compostable, or home compostable. Further, in some embodiments, the shell is biodegradable and the PCM is degradable, biodegradable, industrially compostable, or home compostable. Additionally, in some embodiments, the shell is industrially compostable and the PCM is degradable, biodegradable, industrially compostable, or home compostable. Moreover, in some embodiments, the shell is home compostable and the PCM is degradable, biodegradable, industrially compostable, or home compostable.

Further, in some embodiments, the PCM has a degradability which at least meets the degradability of the shell. Thus, in an embodiment in which the shell is biodegradable, the PCM is at least biodegradable, but may be industrially compostable or home compostable. Further, in certain embodiments, the shell and the PCM have the same or substantially the same degradability as selected from the classes of (a) degradable, (b) biodegradable, (c) industrially compostable, and (d) home compostable.

Methods described herein may further comprise non-reversibly sealing the shell to contain the PCM. Further, in some embodiments, methods described herein further comprise changing a phase of the PCM from a first phase to a second phase. Such methods may, in some embodiments, further comprise reverting the PCM from the second phase to the first phase.

Additionally, in some embodiments, methods described herein further comprise degrading both the shell and the PCM by a biological process consistent with biodegradability. Further, in some embodiments, methods described herein further comprise industrially composting both the shell and the PCM. Moreover, in certain embodiments, methods described herein further comprise home composting both the shell and the PCM.

Further, in another aspect, methods of transporting a product, payload, or goods are described herein. Such a method can comprise placing one or more packages described herein in an interior volume of a container and placing the product in the interior volume of the container. For example, with reference to FIG. 3, a container (200), which may be a box in some cases, comprises a plurality of packages described herein (101, 102, 103). These packages (101, 102, 103) can have a structure described hereinabove in Section I, such as the structure of the package (100) of FIGS. 1 and 2. For clarity, only three packages (101, 102, and 103) are shown disposed in the interior volume (210) of the container (200). Two packages (101, 102) are shown on two sides or along two walls of the container (200), while the third package (103), which is also shaded gray for clarity, is disposed at the bottom or on the “floor” of the container (200). Again for purposes of clarity, the container (200) is illustrated with dashed lines and is treated as though it were optically transparent. The interior volume (210) of the container (200) comprises a product or payload (300), illustrated using a hatching pattern. The product or payload (300) is thus surrounded or contained at least partially by the packages (101, 102, 103). Additional packages described herein (not shown) could also be disposed in the container (200) if desired. For instance, in some cases, up to three additional packages (not shown) could be disposed on the top and along the other two sides of the interior volume (210), such that the payload (300) would be completely surrounded or enclosed on all sides by the packages.

Turning again to methods described herein, a method described herein can further comprise transporting the container from a first location to a second location and removing the product from the interior volume of the container. Additionally, in some embodiments, a method further comprises heating or cooling the PCM of the package above or below a phase transition temperature of the PCM prior to placing the product in the interior volume of the container. Such heating or cooling can effectively “charge” the PCM, e.g., by effecting a phase transition (e.g., to a “frozen” or solid state), which can then be reversed (or partially reversed) during transport due to thermal energy exchange with an external environment of the package or container. In this manner, the PCM can “shield” the payload from the temperature of the external environment and can maintain a desired temperature of the payload (which may be a temperature-sensitive product or payload). Such “charging” as described herein, in some embodiments, comprises effecting a phase transition of at least 50%, at least 60%, at least 70%, at least 80%, at least 90%, or at least 95% of the mass of the PCM. In some cases, such charging comprises fully effecting the desired phase transition. Charging a PCM of a package prior to placing the package in the container can be carried out in any manner not inconsistent with the objectives of the present disclosure. In some cases, for example, the package is placed in a refrigerator or freezer prior to placing the product in the interior volume of the package. It is further to be understood that a package or PCM of a package can be charged or conditioned after it is placed in the container, rather than before it is placed in the container.

Moreover, it is be understood that, in some cases, the PCM has a phase transition temperature that matches or falls within the range of or is selected based on a desired maintenance temperature of the product or payload. As noted above, the product or payload transporting according to a method described herein, in some cases, comprises a temperature-sensitive product, which can be a product that degrades or becomes unusable (due to safety regulations or otherwise) when the temperature of the product exceeds a specified maximum temperature or is below a specified minimum temperature, such as may occur in the case of a pharmaceutical, vaccine, or biological sample that must remain in a temperature range of −15 to −25° C., 2 to 8° C., or 15-25° C. during transportation and/or storage prior to use. For instance, in some embodiments, the product or payload comprises a food, a pharmaceutical, a vaccine, or a biological material or sample such as blood or biological tissue.

Additionally, as described previously, the container of a method described herein is not particularly limited. In some implementations, the container comprises a box or an envelope. In some embodiments, the box can be a one-way or disposable box such as a corrugated cardboard box, with or without insulation. In some cases, the box can be a reusable box or shipper such as a hard sided plastic or metal box or shipper, with or without insulation. In still other instances, the container can be an envelope, such as an envelope used for the shipment of biological samples or other temperature-sensitive or perishable goods, products, or payloads.

It is further to be understood that PCM-containing packages described herein (which may also be referred to as “packaged PCM”) can be disposed within the interior volume of a container in any amount and in any spatial arrangement not inconsistent with the objectives of the present disclosure. For example, in some cases in which the container is a box, a plurality of packages described herein are disposed in the interior volume of the box. For instance, in some embodiments 4-6 PCM-containing packages are disposed along the walls of the interior volume of the box, such as one PCM-containing package on each of the four sides of the box, with an optional additional PCM-containing package placed on the bottom and/or on the top. In this manner, the PCM-containing packages can shield the payload or product (which may be placed in an inner region of the interior) from temperature changes caused by the exterior environment of the box.

Moreover, a method described herein, in some cases, further comprises removing the package from the container and degrading the shell and/or the PCM. In some preferred embodiments, the shell and the PCM are degraded together (e.g., at the same time, in the same space, and/or using the same process). In some such instances, for example, both the shell and the PCM are degraded together using a biological process. In other cases, the method comprises industrially composting both the shell and the PCM together. In still other embodiments, the method comprises home composting both the shell and the phase change material together.

Various implementations of apparatus and methods have been described in fulfillment of the various objectives of the present disclosure. It should be recognized that these implementations are merely illustrative of the principles of the present disclosure. Numerous modifications and adaptations thereof will be readily apparent to those skilled in the art without departing from the spirit and scope of the present disclosure. For example, individual steps of methods described herein can be carried out in any manner and/or in any order not inconsistent with the objectives of the present disclosure, and various configurations or adaptations of apparatus described herein may be used.

1. A package comprising:
a shell and a phase change material (PCM) disposed in the shell, wherein the shell and the PCM each have a degradability selected from the group consisting of (a) degradable, (b) biodegradable, (c) industrially compostable, and (d) home compostable, and
wherein the shell and the PCM are selected to have the same level of degradability selected from the group consisting of (a) degradable, (b) biodegradable, (c) industrially compostable, and (d) home compostable.

2. The package of claim 1, wherein the shell and the PCM are degradable.

3. The package of claim 1, wherein the shell and the PCM are biodegradable.

4. The package of claim 1, wherein the shell and the PCM are industrially compostable.

5. The package of claim 1, wherein the shell and the PCM are home compostable.

6. The package of claim 1, wherein the shell comprises starch-based plastics, bacteria-based plastics, soy-based plastics, cellulose-based plastics, lignin-based plastics, natural fiber reinforced plastics, polycaprolactone (PCL), polyvinyl alcohol (PVA), polyhydroxybutyrate (PHB), polyglycolides (PGA), or polylactic acids (PLA).

7-10. (canceled)

11. A method of making a package comprising:
forming a shell from a first material and disposing at least one PCM in the shell, wherein the shell and the PCM each have a degradability selected from the group consisting of (a) degradable, (b) biodegradable, (c) industrially compostable, and (d) home compostable,
wherein the shell and the PCM are selected to have the same level of degradability selected from the group consisting of (a) degradable, (b) biodegradable, (c) industrially compostable, and (d) home compostable.

12. The method of claim 11 further comprising non-reversibly sealing the shell to encapsulate the PCM.

13. The method of claim 11 further comprising changing a phase of the PCM from a first phase to a second phase.

14. The method of claim 13 further comprising reverting the phase of the PCM from the second phase to the first phase after changing the phase from the first phase to the second phase.

15. The method of claim 11, wherein the shell and the PCM are degradable.

16. The method of claim 11, wherein the shell and the PCM are biodegradable.

17. The method of claim 11, wherein the shell and the PCM are industrially compostable.

18. The method of claim 11, wherein the shell and the PCM are home compostable.

19-23. (canceled)

24. A method of transporting a product comprising:
placing the package of claim 1 in an interior volume of a container;
placing the product in the interior volume of the container;
transporting the container from a first location to a second location; and
removing the product from the interior volume of the container.

25. (canceled)

26. The method of claim 24 further comprising:
heating or cooling the PCM of the package above or below a phase transition temperature of the PCM prior to placing the product in the interior volume of the container.

27. The method of claim 24, wherein the product comprises a food, a pharmaceutical, a vaccine, or a biological material.

28. (canceled)

29. The method of claim 24, wherein the container comprises a box or an envelope.

30. The method of claim 24 further comprising:
degrading both the shell and the PCM together using a biological process.

31. The method of claim 24 further comprising:
industrially composting or home composting both the shell and the PCM together.

32. (canceled)
